(19) United States
(12) Patent Application Publication
(10) Pub. No.: US 2015/0154146 A1
(43) Pub. Date: Jun. 4, 2015

(54) SYSTEM AND METHOD FOR SEARCHING FOR NEW MATERIAL

(71) Applicant: Samsung Electronics Co., Ltd., Suwon-Si (KR)

(72) Inventors: Ji-Ho YOO, Suwon-si (KR); Sang-Heum HWANG, Seoul (KR); Sung-jin KIM, Suwon-si (KR); Sang-hyun LEE, Hwaseong-si (KR); Chan-hee LEE, Seongnam-si (KR)

(21) Appl. No.: 14/558,260

(22) Filed: Dec. 2, 2014

(30) Foreign Application Priority Data
Dec. 3, 2013 (KR) 10-2013-0149495

(51) Int. Cl. G06F 17/18

(52) U.S. Cl. CPC G06F 17/18

(57) ABSTRACT

Example embodiments relate to a system and method for searching for a new material. The example method includes acquiring a substitution tendency matrix X including substitution tendency data of ions based on existing crystal structure data, calculating an ion property matrix U by applying a symmetric matrix factorization model to the substitution tendency matrix X, acquiring substitution tendency prediction data based on the calculated ion property matrix U, and calculating probabilities of substitution of new crystal structures based on the substitution tendency prediction data.

### RELATED APPLICATIONS

This application claims the benefit of priority from Korean Patent Application No. 10-2013-0149495, filed on Dec. 3, 2013, in the Korean Intellectual Property Office, the disclosure of which is incorporated herein in its entirety by reference.

### BACKGROUND

1. Field

Example embodiments relate to a system and method for searching for a new material, and/or to a system and method in which a new material is searched for on the basis of predicted exchange tendency data of ions constituting a crystal of the material.

2. Description of the Related Art

To develop a new material, new materials may be generally searched for through a method of generating a new material candidate group by using already known structures or composition data of materials and verifying the generated new material candidate group.

Meanwhile, by substituting an ion constituting an existing material with another ion, a candidate group for a new material may be generated. At this time, to substitute the ion constituting the existing material with another ion, exchange tendency data of the ion is used.

According to related art, only known exchange tendency data of ions is used. Therefore, when not enough existing data is available, or when most data is concentrated only on particular ions, it is typically difficult to accurately search for a new material.

### SUMMARY

Example embodiments relate to a system and method for searching for a new material in which an unknown ion substitution tendency may be predicted to ensure the diversity of new material candidate groups and accurately predict the probability of substitution of the new material.

Additional example embodiments will be set forth in part in the description which follows and, in part, will be apparent from the description, or may be learned by practice of the example embodiments.

According to an example embodiment, a method of searching for a new material includes acquiring a substitution tendency matrix X including substitution tendency data of ions based on existing crystal or molecular structure data, calculating an ion property matrix U by applying a symmetric matrix factorization model to the substitution tendency matrix X, acquiring substitution tendency prediction data based on the calculated ion property matrix U, and calculating probabilities of substitution in new crystal or molecular structures based on the substitution tendency prediction data.

According to an example embodiment, the symmetric matrix factorization model for the substitution tendency matrix X may be X≈UU^{T}, and the calculating of the ion property matrix U may include calculating the ion property matrix U for minimizing.

According to an example embodiment, the calculating of the ion property matrix U may further include assigning a weight to X−UU^{T} to exclude data indicating that a substitution tendency is unknown from elements of the substitution tendency matrix X during a process of the calculating.

According to an example embodiment, the method may further include acquiring a prior information matrix Y including prior information data, and the calculating of the ion property matrix U may include calculating the ion property matrix U based on the substitution tendency matrix X and the prior information matrix Y.

According to an example embodiment, the calculating of the ion property matrix U may include calculating the ion property matrix U by applying a matrix co-factorization model, which causes the ion property matrix U to be included in the substitution tendency matrix X and the prior information matrix Y in common, to the substitution tendency matrix X and the prior information matrix Y.

According to an example embodiment, the calculating of the ion property matrix U may include calculating the ion property matrix U under a constraint condition that element values of the ion property matrix U are not negative numbers.

According to an example embodiment, the prior information data may include at least one of oxidation number data of the ions and radius data of the ions.

According to an example embodiment, the acquiring of the prior information matrix Y may include determining element values of the prior information matrix Y based on a distribution of the prior information data.

According to an example embodiment, the method may further include generating the new crystal or molecular structures in decreasing order of the probabilities of substitution of the new crystal structures.

According to another example embodiment, a system for searching for a new material includes a substitution tendency extractor that calculates a substitution tendency matrix X including substitution tendency data based on existing crystal structure data, a substitution tendency predictor which calculates an ion property matrix U by applying a symmetric matrix factorization model to the substitution tendency matrix X, and acquires substitution tendency prediction data based on the ion property matrix U, and a substitution probability model builder that calculates probabilities of substitution based on the substitution tendency prediction data.

According to an example embodiment, the symmetric matrix factorization model for the substitution tendency matrix X may be X≈UU^{T}, and the substitution tendency extractor may calculate the ion property matrix U for minimizing X−UU^{T}.

According to an example embodiment, the substitution tendency extractor may assign a weight to X−UU^{T} to exclude data indicating that a substitution tendency is unknown from elements of the substitution tendency matrix X during a process of the calculation.

According to an example embodiment, the system may further include a prior information model builder which calculates a prior information matrix Y including prior information data, and the substitution tendency extractor may calculate the ion property matrix U based on the substitution tendency matrix X and the prior information matrix Y.

According to an example embodiment, the substitution tendency extractor may calculate the ion property matrix U by applying a matrix co-factorization model, which causes the ion property matrix U to be included in the substitution tendency matrix X and the prior information matrix Y in common, to the substitution tendency matrix X and the prior information matrix Y.

According to an example embodiment, the substitution tendency extractor may calculate the ion property matrix U under a constraint condition that element values of the ion property matrix U are not negative numbers.

According to an example embodiment, the prior information model builder may determine element values of the prior information matrix Y based on a distribution of the prior information data.

According to an example embodiment, the system may further include a new crystal or molecular structure predictor which generates new crystal structures in decreasing order of the probabilities of substitution of the new crystal structures.

According to another example embodiment, a program for causing a computer to perform a method of searching for a new material is recorded in a computer-readable recording medium. The method includes acquiring a substitution tendency matrix X including substitution tendency data based on existing crystal structure data, calculating an ion property matrix U by applying a symmetric matrix factorization model to the substitution tendency matrix X, acquiring substitution tendency prediction data based on the calculated ion property matrix U, and calculating a probability of substitution of a new crystal structure based on the substitution tendency prediction data.

According to at least one example embodiment, a method of searching for a new material including determining a substitution tendency for a plurality of ions based on existing crystal structure data, determining a substitution prediction based on the determined substitution tendency, and calculating a probability of synthesizing each of one or more new crystal structures based on the determined substitution prediction data. According to at least one example embodiment, calculating the ion properties includes calculating an interaction between one or more of the plurality of ions and one or more of the new crystal structures, and calculating the interaction includes applying a symmetric factorization model to the determined substitution tendency.

### BRIEF DESCRIPTION OF THE DRAWINGS

These and/or other example embodiments will become apparent and more readily appreciated from the following description, taken in conjunction with the accompanying drawings in which:

FIG. 1 is a block diagram showing a constitution of a system for searching for a new material according to an example embodiment;

FIGS. 2 and 3 are diagrams illustrating an ion exchange tendency according to an example embodiment;

FIG. 4 is a flowchart of a method of searching for a new material according to an example embodiment;

FIG. 5 is a flowchart of a method of searching for a new material according to another example embodiment;

FIG. 6 is a diagram illustrating a method of determining the number of ionic properties according to an example embodiment;

FIG. 7 is a diagram showing a distribution of prior information according to an example embodiment; and

FIG. 8 shows prior information models for some elements according to an example embodiment.

### DETAILED DESCRIPTION

Reference will now be made in detail to example embodiments illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures. Expressions such as “at least one of,” when preceding a list of elements, modify the entire list of elements and do not modify the individual elements of the list.

It will be understood that when an element is referred to as being “on,” “connected” or “coupled” to another element, it can be directly on, connected or coupled to the other element or intervening elements may be present. In contrast, when an element is referred to as being “directly on,” “directly connected” or “directly coupled” to another element, there are no intervening elements present. As used herein the term “and/or” includes any and all combinations of one or more of the associated listed items. Further, it will be understood that when a layer is referred to as being “under” another layer, it can be directly under or one or more intervening layers may also be present. In addition, it will also be understood that when a layer is referred to as being “between” two layers, it can be the only layer between the two layers, or one or more intervening layers may also be present.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

In the drawing figures, the dimensions of layers and regions may be exaggerated for clarity of illustration. Like reference numerals refer to like elements throughout. The same reference numbers indicate the same components throughout the specification.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. As used herein, expressions such as “at least one of,” when preceding a list of elements, modify the entire list of elements and do not modify the individual elements of the list.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain example embodiments of the present description.

In this specification, description will be made by taking ions as an example for convenience, but the example embodiments may be likewise applied to neutral atoms.

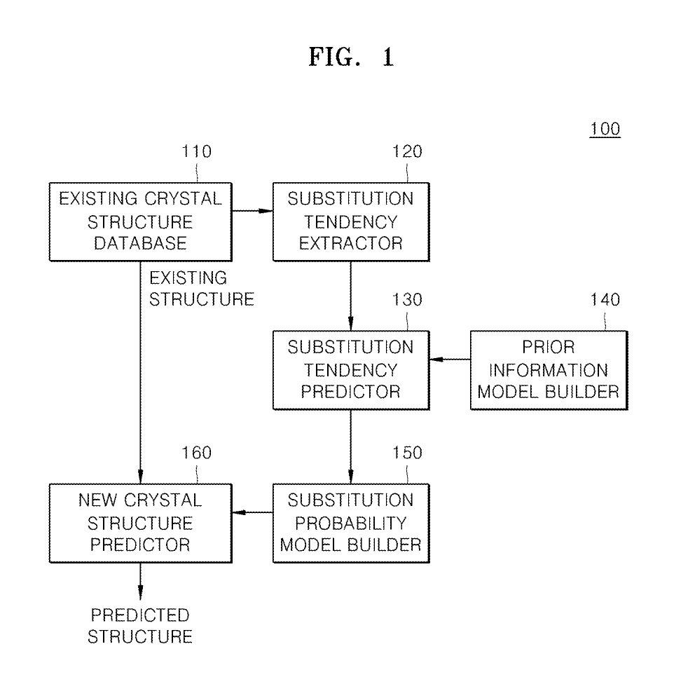

FIG. 1 is a block diagram showing a system 100 for searching for a new material according to an example embodiment.

Referring to FIG. 1, the system 100 for searching for a new material may include an existing crystal or molecular structure database 110, a substitution tendency extractor 120, a substitution tendency predictor 130, a prior information model builder 140, a substitution probability model builder 150, and a new crystal structure predictor 160.

The existing crystal or molecular structure database 110 may be a database including information on the crystal structures of already known materials.

According to an example embodiment, the information on the crystal structures may include the sizes of unit cells of the crystal structures, information on the relative positions of respective atoms included in the crystal structures in the unit cells, and so on.

The substitution tendency extractor 120 may include a processor to group together materials having the same structure, on the basis of the information of an existing crystal structure database, and to analyze the materials which are grouped together based on their same structures and have different ions at the same structural position, thereby extracting or determining substitution tendencies of the ions. For example, the materials may include a first material and a second material. Here, the first material has a crystal structure C1, and the second material has a crystal structure C2. Also, the crystal structure C1 is the same as the crystal structure C2, and a position P1 on the crystal structure C1 is the same as a position P2 on the crystal structure C2. However, an ion I1 located at the position P1 is different than an ion I2 located at the position P2.

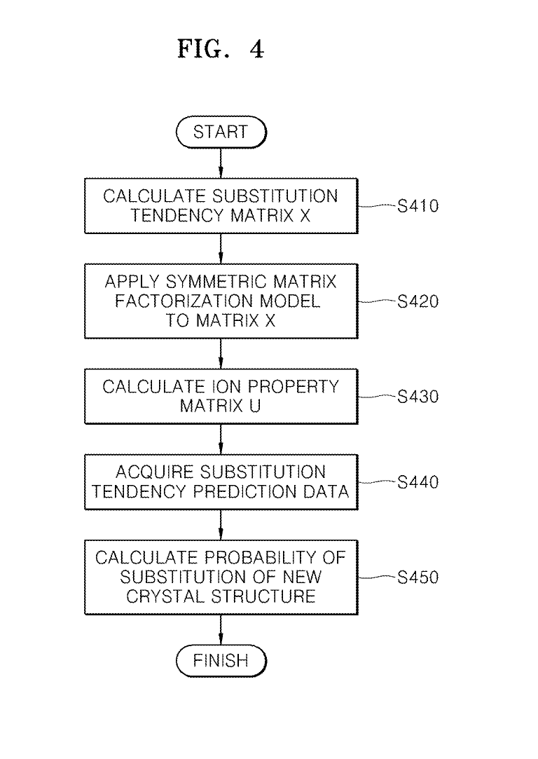

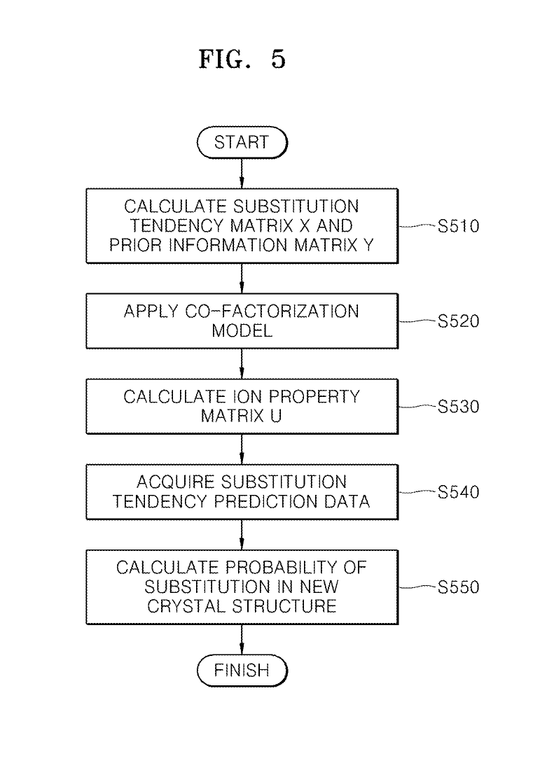

According to at least one example embodiment, the processor may be an arithmetic logic unit, a digital signal processor, a microcomputer, a field programmable array, a programmable logic unit, a microprocessor or any other device capable of responding to and executing instructions in a defined manner such that the processor is programmed with instructions that configure the processing device as a special purpose computer to perform the operations illustrated in FIGS. 4 and 5. The instructions may be stored on a non-transitory computer readable medium. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion.

For example, the substitution tendency extractor 120 may collect the frequency that two ions (or elements) are present at the same position in two materials having the same structure, determine that the higher the frequency, the higher the probability of substitution, that is, the probability that two ions will be substituted for each other, and construct a substitution tendency matrix X according to the probability of substitution. The substitution tendency matrix X is described in detail later.

The prior information model builder 140 may build a prior information model by using known prior information data. For example, the prior information data may include at least one of oxidation number data of ions and radius data of the ions. In particular, the prior information model builder 140 may build a prior information matrix Y by using a distribution of the prior information data. This is described in detail later.

The substitution tendency predictor 130 calculates substitution tendency prediction data by using the substitution tendency matrix X and the prior information matrix Y. Here, the substitution tendency prediction data is a value which denotes an unknown ion substitution tendency.

The substitution probability model builder 150 may calculate the probability of substitution on the basis of the substitution tendency prediction data calculated by the substitution tendency predictor 130.

For example, the probability of substitution between a material A and a material B may be calculated by using the following probability model.

$$p ( A , B ) = \frac{1}{Z} {\prod }_{i = 1}^{n} exp ( {λ}_{{x}^{( i )} {y}^{( i )}} ) , \qquad [ Expression 1 ]$$

In 1/z(.), z is a value for causing the value of (.) function to satisfy a probability condition (that the sum of probability values is 1), and may be calculated by summing (.) values for all possible combinations of A and B. Also, on the basis of the substitution tendency prediction data, a parameter λ may be obtained by repeatedly applying the following expression:

$${λ}_{cd}^{( t + 1 )} = log ( \frac{{R}_{cd}}{{R}_{S} - {R}_{cd}} ) + log ( {\sum }_{( a , b ) ∈ P , ( c , d )} exp ( {λ}_{ab}^{( t )} ) ) . \qquad [ Expression 2 ]$$

Here, λ_{cd} is a parameter obtained where a c ion and d ion are substituted for each other, Rs denotes the sum of all substitution tendency prediction data calculated as UU′, and Rcd denotes substitution tendency prediction data between the c ion and d ion.

The new crystal structure predictor 160 may obtain an existing crystal structure from the existing crystal structure database 110 on the basis of the calculated probability of substitution, and generate a new crystal structure B of new composition by substituting an ion B for an ion A included in the obtained existing crystal structure.

For example, the new crystal structure predictor 160 may generate new crystal structures in order of decreasing probability of substitution. Alternatively, the new crystal structure predictor 160 may generate a new crystal structure only when the probability of substitution is a previously set or a desired value or more.

A method of acquiring substitution tendency prediction data is described in detail below.

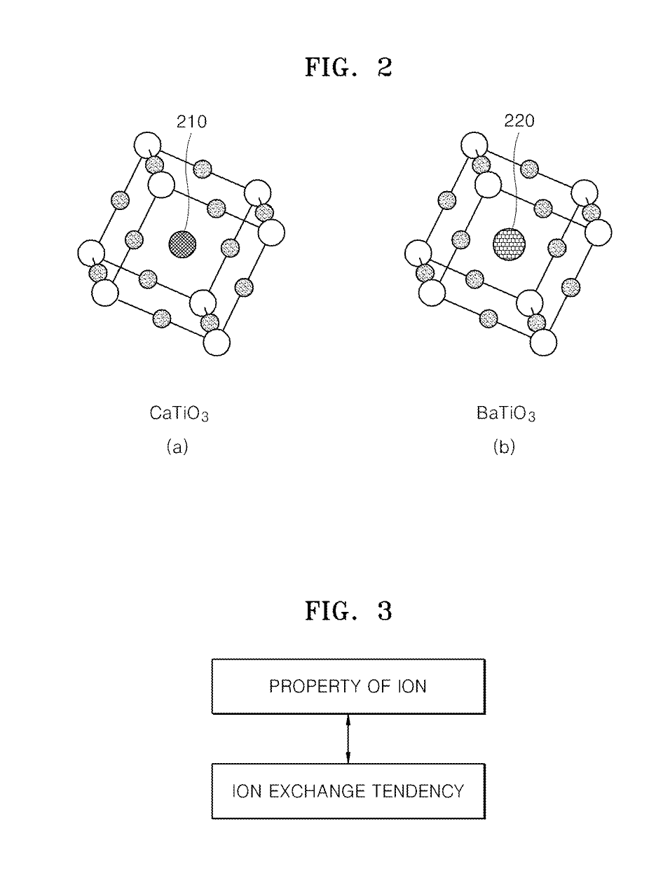

FIGS. 2 and 3 are diagrams illustrating an ion exchange tendency.

An ion exchange tendency may be a value which denotes the probability that two ions can be substituted for each other. For example, calcium titanate (CaTiO₃) of FIG. 2(A) and barium titanium oxide (BaTiO₃) of FIG. 2(B) are materials having the same or equivalent structure, and a calcium ion (Ca²⁺) 210 and a barium ion (Ba²⁺) 220 are present at the same or equivalent position in the two materials, respectively.

As described above, it is possible to assume that different ions present at the same or equivalent position in two materials having the same structure may be substituted for each other. In other words, it is possible to assume that the calcium ion (Ca²⁺) 210 and the barium ion (Ba²⁺) 220 may be substituted for each other.

Also, it is possible to collect the frequency at which two ions are present at the same or equivalent position in two materials having the same or equivalent structure, and determine that the higher the frequency, the higher the probability of substitution between the two ions. As the probability of substitution increases, the amount of substitution tendency data may be larger.

As illustrated in FIG. 3, such an ion substitution tendency may be related to features of the ions. For example, when an ion A and an ion B have similar or the same properties, they may have similar or the same substitution tendencies. Also, when the ion A and the ion B have similar or the same substitution tendencies, they may have similar or the same properties.

Therefore, prediction of an unknown substitution tendency may be performed through a method of 1) extracting properties of an ion which are not directly observed from known substitution tendencies, and 2) predicting the unknown ion substitution tendency from the extracted properties of the ion.

FIG. 4 is a flowchart of a method of searching for a new material according to an example embodiment.

Referring to FIG. 4, the system 100 for searching for a new material may calculate a substitution tendency matrix X (operation 410). Here, the substitution tendency matrix X may include known substitution tendency data between ions. The substitution tendency matrix X is described in detail below.

<<Expression of Substitution Tendency Vector x>>

A substitution tendency of an ion may be expressed in the form of a vector. When substitution tendencies for N ions are expressed, a vector x may have N components, and each of the N components may be a value denoting a substitution tendency of any one ion for one of the N ions.

For example, when xᵢ is presumed to be a substitution tendency vector of an i-th ion among the N ions, a first component x(1i) of xᵢ may be a value denoting a substitution tendency of the i-th ion for a first ion, and a second component x(2i) of xᵢ may be a value denoting a substitution tendency of the i-th ion for a second ion.

When a substitution tendency of the i-th ion for a j-th ion is unknown, a j-th component x(ji) of xᵢ may be set to 0.

The substitution tendency vector xᵢ may be expressed as a linear combination of several ion property vectors (u₁, u₂, . . . , and u_{R}) as follows:

xᵢ≈a₁ᵢ×u₁+a₂ᵢ×u₂+a₃ᵢ×u₃+ . . . +a_{Ri}×u_{R} Expression 3

Here, properties of the ion may be classified into R types, and each uⱼ is a vector denoting a j-th property among the R property types. Meanwhile, uⱼ may have the same size as xᵢ. In other words, uⱼ may have N components.

Also, each value of aⱼᵢ may denote how important the j-th ion property vector is in expressing a substitution tendency of the i-th ion. In other words, each value of aⱼᵢ may be a weight indicating how much of the j-th property the i-th ion has.

Meanwhile, when a substitution tendency vector is expressed in the form of Expression 3, the substitution tendency vector may be expressed with a number of ion property vectors that is smaller than a number of existing ion property vectors. In other words, when the number of existing ion property vectors is Y, the substitution tendency vector may be expressed with only R ion property vectors obtained by condensing the properties of the ion.

These ion property vectors may represent properties of the ion, which are not acquired from existing property data, in a simple form which is easy to recognize.

Meanwhile, the substitution tendency vector xᵢ of the i-th ion may be expressed as follows:

xᵢ≈Uaᵢ Expression 4

An ion property matrix U includes ion property vectors u₁, u₂, . . . , and u_{R} of Expression 3. Thus, for an ion property vector having N components, the size of the ion property matrix U may be N*R.

aᵢ is a weight vector. The weight vector aᵢ has R components, which are the weights a₁ᵢ, a₂ᵢ, . . . , and a_{Ri} of Expression 3.

Meanwhile, substitution tendency vectors (x1, x2, . . . , and xN) of the N ions may be expressed as one substitution tendency matrix X. For example, each column of the substitution tendency matrix X may be configured to represent a substitution tendency vector of an ion, and thus an i-th column of the substitution tendency matrix X may represent the substitution tendency vector xᵢ of the i-th ion.

When a substitution tendency vector of an ion has N components, the size of the matrix X may be N*N, and the matrix X may be a square matrix.

<<Basic Matrix Factorization Model>>

By applying a basic matrix factorization model to the substitution tendency matrix X, the substitution tendency matrix X may be expressed as follows:

X≈UA^{T} Expression 5

Here, U is an ion property matrix, and A is a weight matrix including weight vectors for the N ions. As described above, for weight vector aᵢ having R components, the size of the weight matrix A may be N*R.

A^{T} denotes a transpose matrix of the weight matrix A, which is obtained by interchanging rows and columns of the weight matrix A.

According to an example embodiment, the substitution tendency matrix X denotes the substitution tendency between two ions. In the substitution tendency matrix X, (i, j) element (the substitution tendency between the i-th ion and the j-th ion) and (j, i) element (the substitution tendency between the j-th ion and the i-th ion) have the same value.

Therefore, the substitution tendency matrix X has the form of a symmetric matrix.

In this case, when Expression 5 is applied as it is, it may be difficult to represent the symmetry of the substitution tendency matrix X. In other words, the substitution tendency of the i-th ion for the j-th ion may become different from the substitution tendency of the j-th ion for the i-th ion.

Consequently, it is necessary to use an expression for maintaining the symmetry of the substitution tendency matrix X, and thus a symmetric matrix factorization model may be applied to the substitution tendency matrix X (operation 420).

<<Symmetric Matrix Factorization Model>>

As described above, in the substitution tendency matrix X, both rows and columns denote ions and are symmetrical to each other. Also, in the ion property matrix U, rows denote ions, and columns denote properties of the ions.

On the basis of the characteristics described above, the substitution tendency matrix X may be expressed by using the ion property matrix U as follows:

X≈UU^{T} Expression 6

When Expression 6 is used, it is possible to effectively determine the ion property matrix U while maintaining the symmetry of the substitution tendency matrix X.

The system 100 for searching for a new material may calculate the ion property matrix U by using an expression (operation 430). This is described in detail below.

<<Learning of Matrix Factorization Model>>

As described above, when a matrix factorization model is determined as Expression 6 and the substitution tendency matrix X is given, optimization may be performed to minimize a difference X−UU^{T} between the substitution tendency matrix X and the matrix factorization model UU^{T} so that the ion property matrix U is determined.

By using the Frobenius norm (∥A∥_{F}=Σaᵢⱼ²) of a matrix, the above description may be expressed as the following optimization problem:

argmin_{U}∥X−UU^{T}∥_{F.} Expression 7

When the substitution tendency matrix X is given, the ion property matrix U of Expression 7 may be calculated.

Meanwhile, according to an example embodiment, the above Expression 7 may be expressed as follows:

argmin_{U}∥W⊙X−UU^{T})∥_{F.} Expression 8

Here, W is a weight matrix, serving to exclude data indicating that the corresponding ion substitution tendency is unknown, that is, an element represented as 0 among elements of the substitution tendency matrix X.

For example, when the substitution tendency of the i-th ion for the j-th ion is unknown, (i, j) element and (j, i) element of the substitution tendency matrix X may be represented as 0. Accordingly, the weight matrix W may exclude data indicating that the corresponding ion substitution tendency is unknown so that the ion property matrix U may be calculated.

The weight matrix W has the same size as the substitution tendency matrix X. An element of the weight matrix W may be set to 1 when the corresponding element of the substitution tendency matrix X has an observed value (in the case of a known ion substitution tendency), and to 0 when the corresponding element does not have an observed value (in the case of an unknown ion substitution tendency).

For example, when the substitution tendency of the i-th ion for the j-th ion is unknown and (i, j) element of the substitution tendency matrix X is 0, (i, j) element of the weight matrix W may also be set to 0.

Meanwhile, the operator ⊙ of Expression 8 denotes multiplication of elements of matrices. For example, according to C=A⊙B, (i, j) element of a matrix C may be represented as a product (cᵢⱼ=aᵢⱼ×bᵢⱼ) of (i, j) element of a matrix A and (i, j) element of a matrix B.

Therefore, Expression 8 makes it possible to prevent or reduce having an unobserved value (substitution tendency data indicating that the corresponding ion substitution tendency is unknown) among the elements of the substitution tendency matrix X from being used in an optimization process of calculating the ion property matrix U.

Meanwhile, by using the calculated ion property matrix U, the system 100 for searching for a new material may calculate a reconstructed substitution tendency matrix X′ as follows, and thus acquire substitution tendency prediction data (operation 440).

X′=UU^{T} Expression 9

The reconstructed substitution tendency matrix X′ may include a predicted value (substitution tendency prediction data) for an ion substitution tendency which is not observed in the substitution tendency matrix X.

In other words, an element represented as 0 in the substitution tendency matrix X may be represented as a predicted value (substitution tendency prediction data) of an ion substitution tendency other than 0 in the reconstructed ion exchange tendency matrix X′.

Therefore, it is possible to predict an unknown substitution tendency between two ions, according to at least one example embodiment.

As described in FIG. 1, the system 100 for searching for a new material may calculate the probability of substitution of a new crystal structure on the basis of the substitution tendency prediction data (operation 450).

FIG. 5 is a flowchart of a method of searching for a new material according to another example embodiment.

The system 100 for searching for a new material may expand a model to use additional data (prior information data) as well as substitution tendency data (a substitution tendency matrix X) and calculate an ion property matrix U.

Therefore, the system 100 for searching for a new material may calculate the substitution tendency matrix X and a prior information matrix Y (operation 510).

Here, the prior information matrix Y represents additional properties of ions, and each row of the prior information matrix Y may consist of vectors including additional property data of one ion. When the number of ions is N and there are K additional properties, the prior information matrix Y may have a size of N*K.

Meanwhile, the prior information matrix Y is intended to calculate the ion property matrix U, and thus the system 100 for searching for a new material may apply a matrix co-factorization model to the prior information matrix Y as follows (operation 520):

Y≈UV^{T} Expression 10

In Expression 10, the ion property matrix U used in Expression 5 may be used as-is. A matrix V may be a matrix which represents weights for expressing the prior information matrix Y as properties of ions, or characteristics of additional information.

When some unobserved values are also in the additional information, weighted matrix factorization may be applied as in Expression 8, and then an optimization problem may be derived and expressed as follows:

argmin_{U,V}[∥Wₓ⊙X−UU^{T})∥_{F}+λ∥W_{y}⊙(Y−UV^{T})∥_{F}]. Expression 11

Here, λ is a parameter for balancing two matrix factorizations, and generally serves to compensate for a difference in size between the substitution tendency matrix X and the prior information matrix Y when the difference is large.

Meanwhile, the system 100 for searching for a new material may calculate the ion property matrix U by using Expression 11 (operation 530). This is described in detail below.

To solve the optimization problem shown in Expression 11, an algorithm or process may be used in which repeated optimization is performed to find an answer in stages.

Since there are two target matrices U and V, first, the matrix V is fixed at an arbitrary value, and only the matrix U may be optimized (first operation). Next, the matrix U is fixed at an arbitrary value, and only the matrix V may be optimized (second operation).

The first and second operations are repeatedly performed until the matrices U and V converge, and thus optimum matrices U and V may be calculated.

In the first operation, it is possible to calculate a gradient of an optimization objective function with respect to U and perform optimization while changing U in the corresponding direction.

For example, a gradient of an optimization objective function E of Expression 11 with respect to U may be expressed as the following expression:

$$\frac{\partial E}{\partial U} = - 4 ( {W}_{X} ⊙ X ) U + 4 ( {W}_{X} ⊙ {UU}^{T} ) U - 2 λ ( {W}_{Y} ⊙ Y ) V + 2 λ ( {W}_{Y} ⊙ {UV}^{T} ) V . \qquad [ Expression 12 ]$$

Accordingly, U may be calculated by using the following gradient descent method:

$$U ← U - η \frac{\partial E}{\partial U} . \qquad [ Expression 13 ]$$

Here, η is a parameter for determining the speed of an algorithm or process. When the value of η is excessively large, U may not converge to an arbitrary value, and when the value is small, the convergence speed of the algorithm may be low. Therefore, η may be determined to be a value which causes no problems in the process of testing the algorithm.

In the second operation, it is possible to calculate a gradient of an optimization objective function with respect to V, and perform optimization while changing V in the direction corresponding to the gradient.

For example, a gradient of an optimization objective function E with respect to U may be expressed as the following expression:

$$\frac{\partial E}{\partial V} = - 2 {λ ( {W}_{Y} ⊙ Y )}^{T} U + 2 {λ ( {W}_{Y} ⊙ {UV}^{T} )}^{T} U . \qquad [ Expression 14 ]$$

Likewise, V may be calculated by using the following gradient descent method:

$$V ← V - η \frac{\partial E}{\partial V} . \qquad [ Expression 15 ]$$

By repeatedly performing the first and second operations expressed above with respect to Expressions 14 and 15 until a variation in the value of the objective function E becomes a predetermined or alternatively desired value or less (until the variation converges to a predetermined or alternatively desired value), the ion property matrices U and V may be finally calculated.

<<Addition of Constraint Condition>>

According to at least one example embodiment, a constraint condition may be added to the ion property matrix U. For example, it is possible to add a constraint condition that the values of respective elements of the ion property matrix U may not be negative numbers. Accordingly, elements of the substitution tendency matrix X may not have negative values.

In order to obtain a result which satisfies such a constraint condition, it is possible to add a third operation of projecting the matrix U calculated by repeatedly performing the first and second operations onto an area in which the constraint condition is satisfied.

The third operation may be expressed as the following expression:

$$U ← f ( U - η \frac{\partial E}{\partial U} ) . \qquad [ Expression 16 ]$$

Here, a function ƒ(.) changes a given value into a value which is closest to the given value while satisfying the constraint condition. For example, when the constraint condition is that the values of the elements of the matrix U may not be negative numbers, f(.) is used to simply change negative values among the elements of the matrix U calculated in the first operation into 0.

As described above, the system 100 for searching for a new material may calculate the ion property matrix U by additionally using prior information data, and calculate a reconstructed substitution tendency matrix X′ including substitution tendency prediction data by using the ion property matrix U (operation 540).

In addition, as described in FIG. 1, the system 100 for searching for a new material may calculate the probability of substitution of a new crystal structure on the basis of the substitution tendency prediction data (operation 550).

Description is made in detail below for a method of determining an ion property number R, which is the number of columns of the ion property matrix U, and a method of constructing the prior information matrix Y, according to various example embodiments.

<<Determination of Ion Property Number>>

In a model for expressing the substitution tendency matrix X, such as Expression 3, the number of ion property vectors (u₁, u₂, . . . , and u_{R}) may be defined to be R. Here, as the number of ion property vectors (the number of columns of the ion property matrix U) is increased, the properties of an ion may be expressed more precisely. However, noise included in the calculated ion property matrix U may increase, and a calculation time also increases.

Therefore, it may be advantageous to determine the number of ion property vectors so that the ion property vectors accurately reflect the main property data.

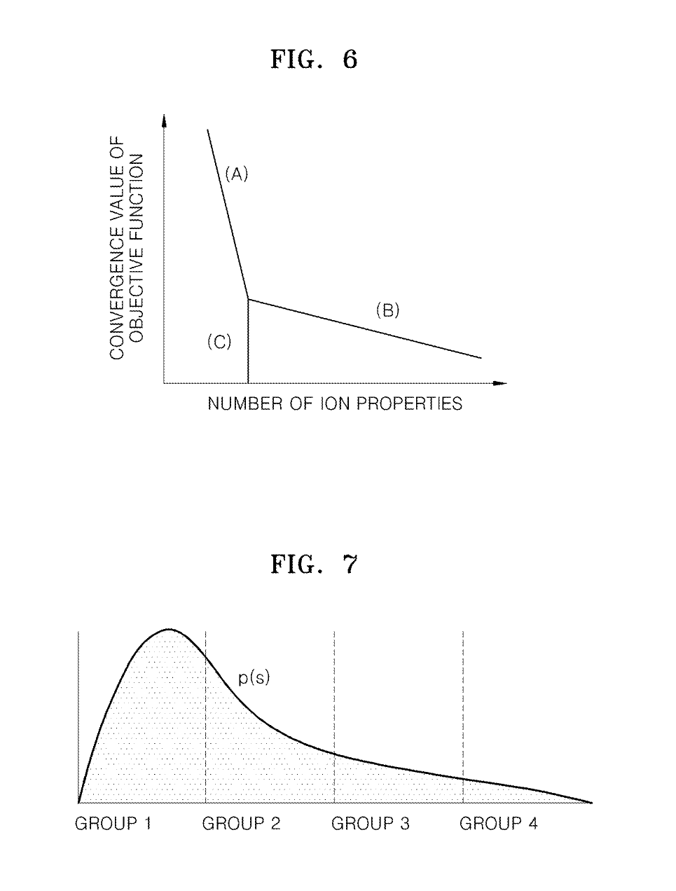

FIG. 6 is a graph illustrating what value an objective function value of an optimization problem converges to according to the ion property number R in at least one example embodiment.

The objective function value is a difference between the substitution tendency matrix X and a factorization model for the substitution tendency matrix X.

Referring to the graph of FIG. 6, as the number of ion properties increases, it becomes possible to give a precise expression, and a convergence value of the objective function is reduced.

Referring to the graph of FIG. 6, in a section (A) where the number of ion properties is small, every time the number of ion properties increases by one, it becomes possible to express a main property of the corresponding ion which is not expressed in a previous model, and the convergence value of the objective function is drastically reduced.

On the other hand, in a section (B) where the number of ion properties is large, even if the number of ion properties continues to increase, no further expressible main properties are available, and the convergence value of the objective function is gradually reduced.

Referring to the tendency of the graph, by finding a boundary between the sections (A) and (B), that is, a point (C) at which the slope of the graph changes, an appropriate number of ion properties, that is, a number of ion properties that accurately reflect main property data may be determined.

Alternatively, as a more quantitative method, a method, such as the Bayesian information criterion (BIC) method or the Akaike information criterion (AIC) method, may be used. In the methods, by giving a penalty based on the complexity of a model, a reduction in the slope of the graph is prevented so that the number of ion properties may be clearly determined.

A method of constructing the prior information matrix Y is described in detail below.

<<Construction of Prior Information Matrix Y>>

Prior information on an ion according to an example embodiment may include an ionic radius and an oxidation number. This is based on Goldberg's law that ion substitution of a crystal structure is enabled when two ions have similar or the same ionic radii and no significant difference in oxidation number.

Meanwhile, both an oxidation number and an ionic radius are not accurately determined values but are values distributed in a certain range. In particular, in many cases, an ionic radius is not measured for a particular oxidation number.

For example, the prior information data may be expressed as a distribution curve p(s) as shown in FIG. 7.

To construct a matrix from prior information which has a particular distribution in consecutive sections, the amount of ions distributed in a particular section may be used.

For example, the amount of i-th ions distributed in a j-th range group may be calculated, and the calculated value may be set as the value of (i, j) element of the prior information matrix Y.

Here, each element value may be expressed as an integral value of a distribution in the corresponding section as the following expression:

Yᵢⱼ=∫_{Bi}^{Ei}pᵢ(s)ds. Expression 17

Here, pᵢ(s) denotes a distribution of prior information s on the i-th ion, and Bi and Ei denote a start point and an end point of a j-th property section, respectively.

For example, when a distribution curve p(s) shown in FIG. 7 shows a distribution of radius data of the i-th ion and a range of an ionic radius is divided into four sections (a section from a zeroth radius to a first radius, a section from the first radius to a second radius, a section from the second radius to a third radius, and a section from the third radius to a fourth radius), an (i, 1) element of the prior information matrix Y may be a value obtained by integrating the distribution curve p(s) from the zeroth radius to the first radius.

Also, an (i, 2) element of the prior information matrix Y may be a value obtained by integrating the distribution curve p(s) from the first radius to the second radius, an (i, 3) element of the prior information matrix Y may be a value obtained by integrating the distribution curve p(s) from the second radius to the third radius, and an (i, 4) element of the prior information matrix Y may be a value obtained by integrating the distribution curve p(s) from the third radius to the fourth radius.

A method of determining the distribution pᵢ(s) of prior information is described in detail below.

<<Determination of Basic Prior Information>>

When prior information is an oxidation number, a normal distribution which has a certain variance with respect to the known oxidation number may be used.

For example, when the oxidation number of an ion is +2, a normal distribution with an average of +2 and a standard deviation of 1 may be used as a distribution for the oxidation number of the ion. For example, the value of the standard deviation may be determined on the basis of known prior knowledge.

Meanwhile, when prior information is about ionic radius, ionic radii for all possible oxidation numbers may not be measured, and an unknown radius value may be present.

In addition, according to a crystal structure, the oxidation number of an ion may not be an integer but may be a real number. In this case, there may be no information on the ionic radius of the ion having an oxidation number which is a real number.

When known information is limited as above, the final distribution of prior information values may be determined through regression analysis.

<<Determination of Distribution of Prior Information Through Probabilistic Regression Analysis Model>>

A principle where the larger the oxidation number of an ion, the smaller the radius of the ion may hold. This is because, as the oxidation number increases, the number of electrons included in the ion is reduced, and the ionic radius decreases.

This relationship may be expressed by using a simple linear model. By probabilistically modeling the relationship and calculating a post probability, a distribution of ionic radius values for an arbitrary oxidation number may be determined. First, a likelihood of a known ionic radius value t may be expressed by using a normal distribution as follows:

p(t|X,w,β)=Πᵢ₌₁^{M} [symbol] (tᵢ|w^{T}xᵢ,β⁻¹). Expression 18

Here, X is a matrix including input values, such as a given oxidation number, etc., and a vector w is a parameter representing a linear relationship between an ionic radius and an oxidation number. β is a parameter indicating the error size of a model. [symbol] (x|a, b) denotes a value corresponding to x in a normal distribution with an average of a and a variance of b. Also, a prior probability relative to the parameter w, which is desired to be calculated, may be expressed as the following normal distribution:

p(w)= [symbol] (w|m₀,S₀) Expression 19

Here, m₀ and S₀ are initial values of an average and a variance given to the parameter, respectively. When there is no other information, a zero vector and an identity matrix are used as m₀ and S₀.

Meanwhile, when the post probability is calculated from the likelihood and the prior probability according to Bayesian theory, the post probability may be expressed as follows:

p(w|t)= [symbol] (w|m_{N},S_{N}),

m_{N}=S_{N}(S₀⁻¹m₀+βX^{T}t)

S_{N}=(S₀⁻¹+βX^{T}X) Expression 20

By applying the above equations to a known ionic radius, it is possible to calculate a distribution of radius values for an arbitrary oxidation number of a target ion. A detailed calculation of the distribution may be made by calculating a predictive probability distribution on the basis of the post probability, and the predictive probability distribution may be expressed as a normal distribution as follows:

p(t|t,X,β)= [symbol] (t|m_{N}^{T}x,β⁻¹+x^{T}S_{N}x). Expression 21

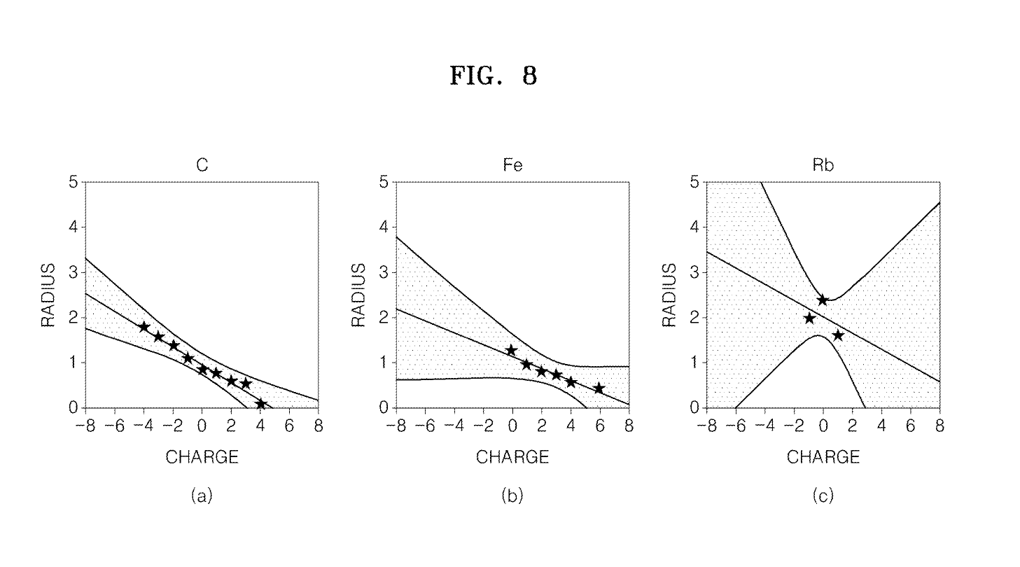

FIG. 8 shows graphs of distributions of radius values of C, Fe, and Rb relative to oxidation numbers according to the above expression.

Referring to the graphs, the illustrated points shown in the graphs denote known valence-specific ionic radius data, and the linear straight lines denote distributions of ionic radii calculated for arbitrary oxidation numbers by using the data. Shaded areas denote standard deviations. The standard deviations in FIG. 8 are shown to be narrow in a predictable portion and wide in an unpredictable portion.

A system and method for searching for a new material according to example embodiments are not limited to constitutions and methods of the above-described example embodiments, and all or some of the example embodiments may be selectively combined so that various modifications may be made.

As described above, according to the one or more of the above example embodiments, an unknown ion substitution tendency between ions may be predicted, and thus the reliability of results of a search for a new material may be increased.

Also, by using prior information data, it is possible to ensure the diversity of new materials groups, and information accumulated during a research process may be used for the development of a new material in an integrated manner.

Example embodiments allow for the prediction of new and yet-unknown material structures based on the high probability of ion substitution in a crystal structure corresponding to the new materials. As a result, new material structures may be discovered without having to undergo lengthy and expensive trial and error.

According to example embodiments, in the case of materials that are typically difficult and expensive to manufacture such as, e.g., drugs, cosmetics, carbon fiber, batteries, semiconductors, and the like, example embodiments provide methods of conceiving new material structures. For example, a Si—Ge (Group IV) semiconductor arranged in a diamond crystalline configuration and including one or more dopants may be predicted based on the probability of ion substitution of a dopant. Alternatively, Group III and Group V semiconductors forming a cubic-crystal configuration may also be predicted based on the ion substitution tendency of the atoms constituting the crystal, or on the ion substitution tendency of dopants.

In addition, other example embodiments can also be implemented through computer readable code/instructions in/on a medium, e.g., a computer readable medium, to control at least one processing element to implement any above described example embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more example embodiments. The media may also be a distributed network, so that the computer readable code is stored/transferred and executed in a distributed fashion. Furthermore, the processing element could include a processor or a computer processor, and processing elements may be distributed and/or included in a single device.

It should be understood that the example embodiments described therein should be considered in a descriptive sense only and not for purposes of limitation. Descriptions of features within each example embodiment should typically be considered as available for other similar or the same features in other example embodiments.

While one or more example embodiments have been described with reference to the figures, it will be understood by those of ordinary skill in the art that various changes in form and details may be made therein without departing from the spirit and scope defined by the following claims.

What is claimed is:

1. A method of searching for a new material, comprising:
determining a substitution tendency matrix X including substitution tendency data of ions based on existing crystal structure data;
calculating an ion property matrix U by applying a symmetric matrix factorization model to the substitution tendency matrix X;
determining substitution tendency prediction data based on the calculated ion property matrix U; and
calculating probabilities of substitution of new crystal structures based on the substitution tendency prediction data.

2. The method of claim 1, wherein the symmetric matrix factorization model is X≈UU^{T}, and
the calculating of the ion property matrix U comprises calculating the ion property matrix U for minimizing X−UU^{T}.

3. The method of claim 2, wherein the calculating of the ion property matrix U further comprises assigning a weight to X−UU^{T} to exclude data indicating that a substitution tendency is unknown from elements of the substitution tendency matrix X during a process of the calculating.

4. The method of claim 1, further comprising acquiring a prior information matrix Y including prior information data,
wherein the calculating of the ion property matrix U comprises calculating the ion property matrix U based on the substitution tendency matrix X and the prior information matrix Y.

5. The method of claim 4, wherein the calculating of the ion property matrix U comprises applying a matrix co-factorization model, which includes the ion property matrix U in the substitution tendency matrix X and the prior information matrix Y, to the substitution tendency matrix X and the prior information matrix Y.

6. The method of claim 4, wherein the calculating of the ion property matrix U comprises calculating the ion property matrix U under a constraint condition where element values of the ion property matrix U are not negative numbers.

7. The method of claim 4, wherein the prior information data includes at least one of oxidation number data and radius data.

8. The method of claim 4, wherein the acquiring of the prior information matrix Y comprises determining element values of the prior information matrix Y based on a distribution of the prior information data.

9. The method of claim 1, further comprising generating the new crystal structures in order of the probabilities of substitution of the new crystal structures.

10. A system for searching for a new material, comprising:
a substitution tendency extractor configured to calculate a substitution tendency matrix X including substitution tendency data based on existing crystal structure data;
a substitution tendency predictor configured to calculate an ion property matrix U by applying a symmetric matrix factorization model to the substitution tendency matrix X, and configured to acquire substitution tendency prediction data based on the ion property matrix U; and
a substitution probability model builder configured to calculate probabilities of substitution based on the substitution tendency prediction data.

11. The system of claim 10, wherein the symmetric matrix factorization model for the substitution tendency matrix X is X≈UU^{T}, and
the substitution tendency extractor is configured to calculate the ion property matrix U for minimizing X−UU^{T}.

12. The system of claim 11, wherein the substitution tendency extractor is configured to assign a weight to X−UU^{T} to exclude data indicating that a substitution tendency is unknown from elements of the substitution tendency matrix X during a process of the calculation.

13. The system of claim 10, further comprising a prior information model builder configured to calculate a prior information matrix Y including prior information data,
wherein the substitution tendency extractor is configured to calculate the ion property matrix U based on the substitution tendency matrix X and the prior information matrix Y.

14. The system of claim 13, wherein the substitution tendency extractor is configured to calculate the ion property matrix U by applying a matrix co-factorization model, which causes the ion property matrix U to be included in the substitution tendency matrix X and the prior information matrix Y in common, to the substitution tendency matrix X and the prior information matrix Y.

15. The system of claim 13, wherein the substitution tendency extractor is configured to calculate the ion property matrix U under a constraint condition where element values of the ion property matrix U are not negative numbers.

16. The system of claim 13, wherein the prior information data includes at least one of oxidation number data and radius data.

17. The system of claim 13, wherein the prior information model builder is configured to determine element values of the prior information matrix Y based on a distribution of the prior information data.

18. The system of claim 10, further comprising a new crystal structure predictor that is configured to generate new crystal structures in order of the probabilities of substitution of the new crystal structures.

19. A computer-readable recording medium storing a program for causing a computer to perform a method of searching for a new material, wherein the method comprises:
acquiring a substitution tendency matrix X including substitution tendency data based on existing crystal structure data;
calculating an ion property matrix U by applying a symmetric matrix factorization model to the substitution tendency matrix X;
acquiring substitution tendency prediction data based on the calculated ion property matrix U; and
calculating a probability of substitution of a new crystal structure based on the substitution tendency prediction data.

20. A method of searching for a new material, comprising:
determining a substitution tendency for a plurality of ions based on existing crystal structure data;
determining a substitution prediction based on the determined substitution tendency; and
calculating a probability of synthesizing one or more new crystal structures based on the determined substitution prediction data.
